(19) United States
(12) Patent Application Publication
(10) Pub. No.: US 2007/0114862 A1
(43) Pub. Date: May 24, 2007

(54) Motor having stator made of soft magnetic powder material

(75) Inventors: Young-Nam Cha, Seoul (KR); Nam-Chul Shin, Seoul (KR)

Correspondence Address: BACON & THOMAS, PLLC, 625 SLATERS LANE, FOURTH FLOOR, ALEXANDRIA, VA, 22314, US

(73) Assignee: DAEWOOD ELECTRONICS CORPORATION, Seoul (KR)

(21) Appl. No.: 11/603,008

(22) Filed: Nov. 22, 2006

(30) Foreign Application Priority Data
Nov. 23, 2005 (KR) 10-2005-0112294
Nov. 23, 2005 (KR) 10-2005-0112297

(51) Int. Cl. H02K 5/00; H02K 1/12

(52) U.S. Cl. 310/89; 310/254

(57) ABSTRACT

A motor includes, a stator made of compressed soft magnetic powder, with a plurality of bolt holes formed around a circumferential outer surface of an end of the stator; a cover fitted over the end of the stator, with a plurality of coupling position adjustment parts provided around an end of the cover, the coupling position adjustment parts each comprising a plurality of through holes arranged in a direction in which the cover is fitted over the stator; and a plurality of coupling bolts, each of the plurality of coupling bolts being tightened into each of the bolt holes of the stator through the selected through hole of the associated coupling position adjustment part of the cover such that a position at which the cover is coupled to the stator is adjustable.

### FIELD OF THE INVENTION

The present invention relates generally to motors having stators made of soft magnetic powder material and, more particularly, to a motor having a stator made of soft magnetic powder material which is constructed such that a cover is easily coupled to the stator without extra coupling members, thus simplifying a process of assembling the cover with the stator.

### BACKGROUND OF THE INVENTION

As well known to those skilled in the art, motors are devices which convert electric energy into mechanical energy to provide rotating force. Such motors are widely used in industrial apparatuses as well as in domestic electronic products. Motors are classified into DC motors and AC motors. A typical motor includes a stator, around which a coil is wound, and a rotor, which is rotatably provided in the stator at a position spaced apart from the inner surface of the stator at a predetermined gap and is rotated by magnetic flux generated in the coil.

Meanwhile, in the motor, the stator is fastened to a casing or cover by various methods. With regard to this, a conventional motor will be explained with reference to the attached drawing.

FIG. 1 is an exploded view showing critical parts of the conventional motor. As shown in the drawing, in the conventional motor 10, a shaft 14 is supported by a pair of covers 11 and 12 so as to be rotatable using bearings 14a and 14b, and a stator 13 is fastened between the covers 11 and 12 using a plurality of nuts N and bolts B.

The covers 11 and 12 have insert holes 11a and 12a at positions corresponding to each other such that the bolts B can be inserted through the covers 11 and 12.

Furthermore, a rotor 15, through the center of which the shaft 14 is fastened, is provided in the stator 13 at a position spaced apart from the inner surface of the stator 13 by a predetermined gap. The stator 13 is formed by layering silicon steel plates having the same shape. Insert holes 13a for insertion of the bolts B are formed in the stator 13.

To assemble the conventional motor 10 having the above-mentioned construction, the stator 13 is disposed between the covers 11 and 12 such that the insert holes 11a, 12a and 13a thereof are aligned with each other, and the bolts B are thereafter inserted into the insert holes 11a, 12a and 13a and tightened into the respective nuts N, thus completing the process of assembling the stator 13 and the covers 11 and 12 together.

However, in the conventional motor 10, because the stator 13 is made of layered silicon steel plates having the same shape, the structure for coupling the covers 11 and 12 to the stator 13 is limited, so that the stator 13 and the covers 11 and 12 must be coupled to each other using extra members such as the nuts N and bolts B. Therefore, when the covers 11 and 12 are coupled to the stator 13, all nuts N and bolts B, which are the coupling members, must be coupled to each other one by one, and the stator 13 and a pair of covers 11 and 12 must be assembled together through a single process. Hence, the insert holes 11a, 12a and 13a of the stator 13 must be aligned all at the same time, thereby making the assembly process inconvenient and reducing the productivity. Furthermore, the production costs are made increased due to the increased expenses for the extra coupling members B and N.

Typically, motors have various sizes and structures, for they are used in various products and apparatuses. However, the conventional motor 10 is problematic in that, when it is required to change the standard size of the motor 10, such as the length and height of the inner space, the stator as well as the covers must be re-engineered.

### SUMMARY OF THE INVENTION

Accordingly, the present invention has been made keeping in mind the above problems occurring in the prior art, and an object of the present invention is to provide a motor having a stator made of soft magnetic powder material in which a process of assembling a cover to the stator is simple, and standard sizes such as the length of the space inside the motor can be easily changed, so that the covers and the stators thereof are compatible with products having different standard sizes, thus reducing the production costs.

Another object of the present invention is to provide a motor having a stator made of soft magnetic powder material which is constructed such that a cover can be easily coupled to the stator without requiring extra coupling members, so that the process of assembling the motor is simplified, thereby increasing productivity and reducing the cost of the assembly process and thus the overall production costs.

In an aspect, the present invention provides a motor, including: a stator made of compressed soft magnetic powder, with a plurality of bolt holes formed around a circumferential outer surface of an end of the stator; a cover fitted over the end of the stator, with a plurality of coupling position adjustment parts provided around an end of the cover, the coupling position adjustment parts each comprising a plurality of through holes arranged in a direction in which the cover is fitted over the stator; and a plurality of coupling bolts, each of the plurality of coupling bolts being tightened into each of the bolt holes of the stator through the selected through hole of the associated coupling position adjustment part of the cover such that a position at which the cover is coupled to the stator is adjustable.

In another aspect, the present invention provides a motor, including: a stator made of compressed soft magnetic powder, with a plurality of coupling position adjustment parts provided around a circumferential outer surface of an end of the stator, the coupling position adjustment parts each comprising a plurality of bolt holes arranged in a longitudinal direction of the stator; a cover fitted over the end of the stator, with a plurality of through holes formed around a circumferential surface of the cover, each of the plurality of through holes being aligned with one of the bolt holes of the associated coupling position adjustment part of the stator; and a plurality of second coupling bolts, each of the plurality of second coupling bolts being tightened into the selected bolt hole of each of the coupling position adjustment parts of the stator through the associated through hole of the cover such that a position at which the cover is coupled to the stator is adjustable.

In another aspect, the present invention provides a motor, including: a stator made of compressed soft magnetic powder, with a plurality of coupling protrusions provided around a circumferential outer surface of an end of the stator; and a cover fitted over the end of the stator, with a plurality of coupling position adjustment parts provided around an end of the cover, the coupling position adjustment parts each comprising a plurality of coupling holes arranged in a direction in which the cover is fitted over the stator, each of the plurality of coupling protrusions of the stator being inserted into the selected coupling hole of the associated coupling position adjustment part of the cover such that a position at which the cover is coupled to the stator is adjustable.

In another aspect, the present invention provides a motor, including: a stator made of compressed soft magnetic powder, with a plurality of coupling position adjustment parts provided around a circumferential outer surface of an end of the stator, the coupling position adjustment parts each comprising a plurality of coupling holes arranged in a longitudinal direction of the stator; and a cover fitted over the end of the stator, with a plurality of coupling protrusions provided around a circumferential inner surface of the cover, each of the plurality of coupling protrusions inserted into the selected coupling hole of the associated coupling position adjustment part of the stator such that a position at which the cover is coupled to the stator is adjustable.

In another aspect, the present invention provides a motor having a stator, to which a cover is coupled. The stator is made of compressed soft magnetic powder and has on an end thereof a plurality of insert protrusions, which are force-fitted into respective insert holes formed in the cover.

In another aspect, the present invention provides a motor having a stator, to which a cover is coupled. The stator is made of compressed soft magnetic powder, and a locking groove is formed around a circumferential outer surface of an end of the stator such that a caulking part to be formed by caulking in the cover fitted over the end of the stator is inserted into and locked to the locking groove of the stator.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded view showing critical parts of a motor according to a conventional technique;

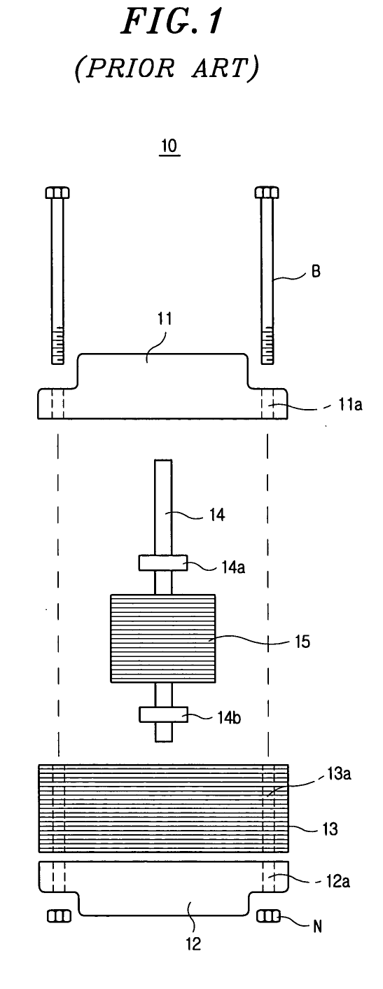

FIG. 2 is an exploded view showing critical parts of a motor having a stator made of soft magnetic powder material, according to a first embodiment of the present invention;

FIGS. 3A and 3B are views illustrating the assembled motor of FIG. 2;

FIG. 4 is an exploded view showing critical parts of a motor having a stator made of soft magnetic powder material, according to a second embodiment of the present invention;

FIGS. 5A and 5B are views illustrating the assembled motor of FIG. 4;

FIG. 6 is an exploded view showing critical parts of a motor having a stator made of soft magnetic powder material, according to a third embodiment of the present invention;

FIGS. 7A and 7B are views illustrating the assembled motor of FIG. 6;

FIG. 8 is an exploded view showing critical parts of a motor having a stator made of soft magnetic powder material, according to a fourth embodiment of the present invention;

FIGS. 9A and 9B are views illustrating the assembled motor of FIG. 8;

FIG. 10 is an exploded view showing critical parts of a motor having a stator made of soft magnetic powder material, according to a fifth embodiment of the present invention; and

FIGS. 11A and 11B are assembled views showing critical parts of a motor having a stator made of soft magnetic powder material, according to a sixth embodiment of the present invention.

### DETAILED DESCRIPTION OF THE PREFERRED EMBODIMENT

Hereinafter, preferred embodiments of the present invention will be described in detail with reference to the attached drawings, such that those skilled in the art can easily implement the present invention.

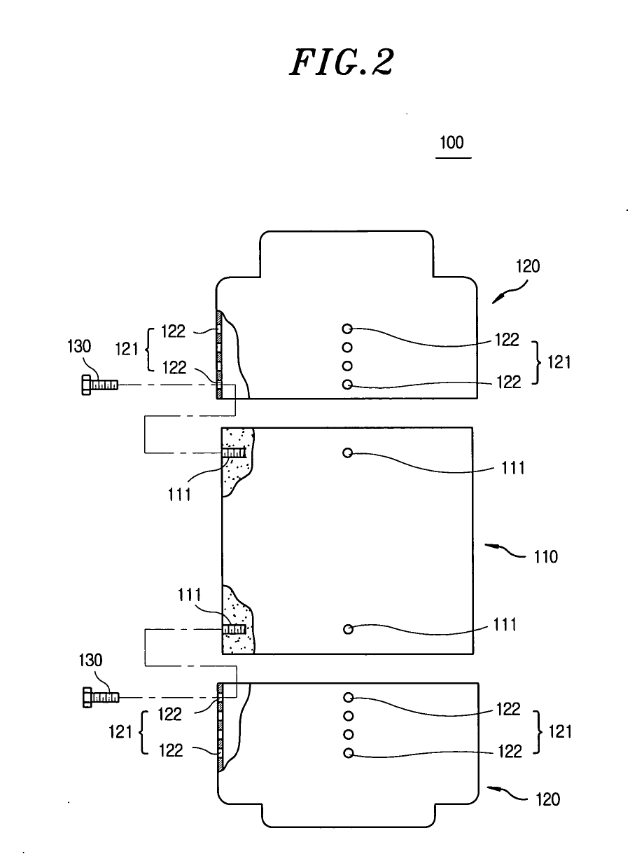

FIG. 2 is an exploded view showing critical parts of a motor 100 having a first stator 110 made of soft magnetic powder material, according to a first embodiment of the present invention. As shown in the drawing, the motor 100 according to the first embodiment of the present invention includes the first stator 110, which is made of compressed soft magnetic powder and has a plurality of bolt holes 111 therein, and first covers 120, which are fitted over the respective opposite ends of the first stator 110, and each of which has first coupling position adjustment parts 121 therein. The motor 100 of the first embodiment further includes first coupling bolts 130, which couple the first covers 120 to the first stator 110.

Teeth (not shown), around each of which a coil (not shown) is wound, are formed on the circumferential inner surface of the first stator 110 at positions spaced apart from each other at regular intervals. Furthermore, a rotor (not shown) is rotatably provided in the first stator 110 at a position spaced apart from the circumferential inner surface of the first stator 110 by a predetermined gap. The several bolt holes 111 are formed in the circumferential outer surface of an end of the first stator 110 at positions spaced apart from each other at regular angular intervals.

The bolt holes 111 may be formed in only one end of the first stator 110 to provide a coupling to the first cover 120. In the present embodiment, the bolt holes 111 are formed in the opposite ends of the first stator 110, so that the first covers 120 are coupled to the respective opposite ends of the first stator 110 using the first coupling bolts 130 so that the position thereof is adjustable.

The first stator 110 is made of compressed soft magnetic powder. The soft magnetic powder mainly comprises iron-based grains. Each grain of the soft magnetic powder is coated with a predetermined material for electrical insulation.

To form the first stator 110 using soft magnetic powder through a compression molding process, a compression molding machine, in which a molding cavity having a shape corresponding to the first stator 110 is defined, is provided. Thereafter, soft magnetic powder is charged into the molding cavity and is compressed by a compressing unit such as a press, thus being manufactured into the shape of the first stator 110 having the teeth and the bolt holes 111. Here, a lubricant and/or binder may be added to the soft magnetic powder before the compressing process is conducted.

As such, the first stator 110 comprises a soft magnetic composite (SMC), which has a three-dimensional shape and is manufactured through the process of compressing soft magnetic powder. Thus, a degree of freedom higher than that of the conventional art, which uses silicon steel plates, is achievable. Therefore, the bolt holes 111 can be easily formed, unlike the conventional structure, in which silicon steel plates having the same shape are layered.

The first cover 120, one of which is fitted over each end of the first stator 110, has therein space sufficient to adjust the depth to which the stator 110 is inserted into the first cover 120. The first coupling position adjustment parts 121 are formed in the circumferential outer surface of an end of the first cover 120 at positions spaced apart from each other at regular angular intervals.

In this embodiment, the first covers 120 comprise a pair of top and bottom covers, which are respectively coupled to the upper and lower ends of the first stator 110. Each of the top and bottom covers 120 is fitted over one end of the first stator 110 and has the first coupling position adjustment parts 121, which are formed in the circumferential outer surface of one end of the cover 120 at regular angular intervals.

Each first coupling position adjustment part 121 comprises a plurality of through holes 122, which are arranged in the direction in which the first stator 110 is fitted into the first covers 120.

The number of first coupling bolts 130 is equal to the number of bolt holes 111 formed in the first stator 110. Furthermore, each first coupling bolt 130 is tightened into each bolt hole 111 of the first stator 110 after passing through the selected through hole 122 of the associated first coupling position adjustment part 121, thus the position at which each first cover 120 is fastened to the first stator 110 is adjustable.

The operation and effect of the above-mentioned motor 100 having the stator made of soft magnetic powder material according to the first embodiment of the present invention will be explained herein below.

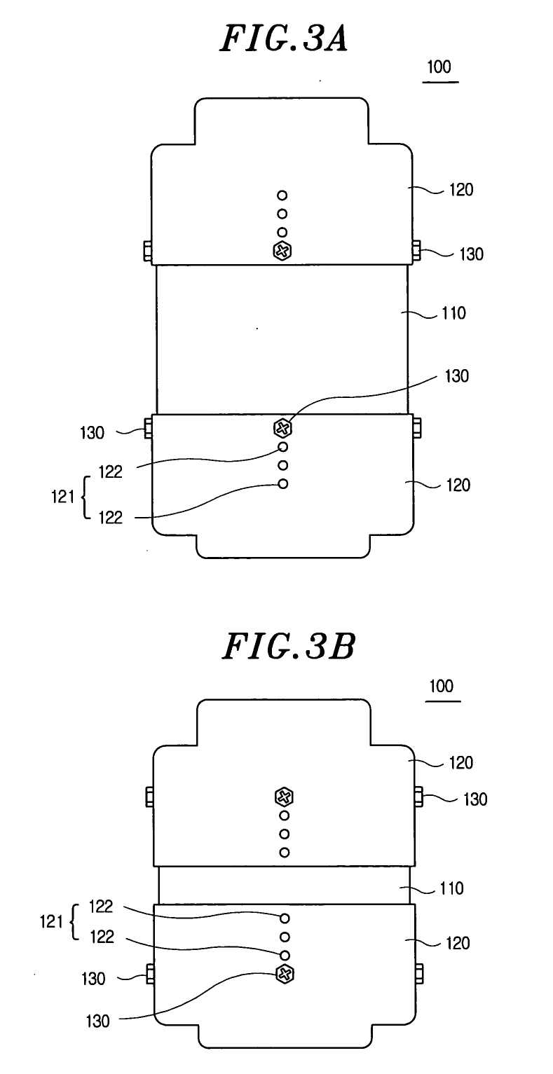

As shown in FIGS. 3A and 3B, the first covers 120 are fitted over the respective opposite ends of the first stator 110. Thereafter, the first coupling bolts 130 are tightened into the respective bolt holes 111 of the first stator 110 via the selected through holes 122 of the respective first coupling position adjustment parts 121, thus fastening the first covers 120 to the first stator 110. At this time, each first coupling bolt 130 passes through a selected one of the through holes 122 of the associated first coupling position adjustment part 121, so that the distance between the first covers 120 can be adjusted to change the length of the space in the motor 100.

In the case where the first coupling position adjustment parts 121, each of which has four through holes 122, are provided in each first cover 120, the length of the motor 100 is adjustable into eight values including the maximum length of the motor 100 shown in FIG. 3A and the minimum length of the motor 100 shown in FIG. 3B.

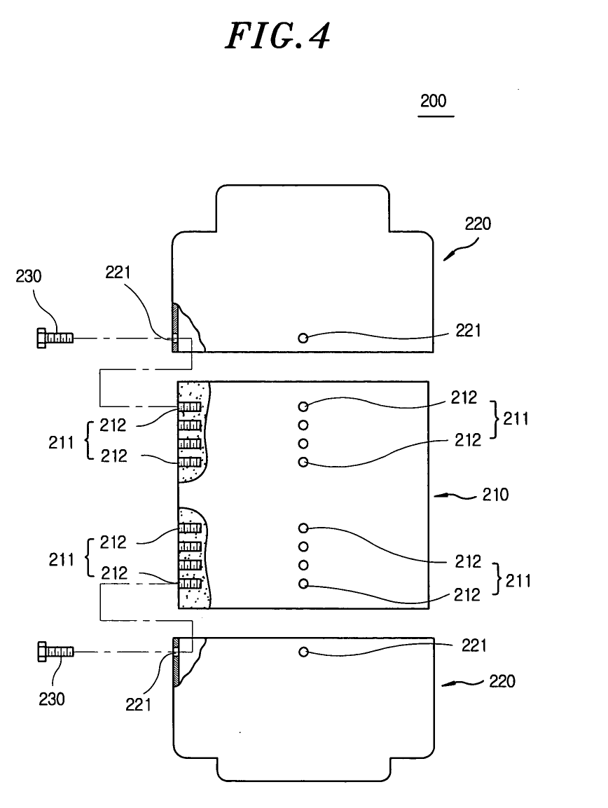

FIG. 4 is an exploded view showing the critical parts of a motor 200 having a second stator 210 made of soft magnetic powder material, according to a second embodiment of the present invention. As shown in the drawing, the motor 200 according to the second embodiment of the present invention includes the second stator 210, which is made of compressed soft magnetic powder and has a plurality of second coupling position adjustment parts 211 therein, and second covers 220, which are fitted over the respective opposite ends of the second stator 210, and each of which has a plurality of through holes 221. The motor 200 of the second embodiment further includes second coupling bolts 230, which couple the second covers 220 to the second stator 210. Hereinafter, the motor 200 according to the second embodiment will be explained in detail, focusing on the differences from the first embodiment.

In the second embodiment, the second stator 210 is formed by compressing soft magnetic powder using a compressing machine, so that the second coupling position adjustment parts 211 are formed in the circumferential outer surface of each end of the second stator 210 at positions spaced apart from each other at regular angular intervals.

Each second coupling position adjustment part 211 comprises a plurality of bolt holes 212, which are arranged in the longitudinal direction of the second stator 210.

The second stator 210 has the second coupling position adjustment parts 211 on respective opposite ends thereof, so that the positions at which the second cover 220 is fastened to each end of the second stator 210 using the second coupling bolts 230 are independently adjustable.

The motor 200 has the two second covers 220, which are fitted over respective opposite ends of the second stator 210. The through holes 221, each of which is aligned with the selected bolt hole 212 of the associated second coupling position adjustment part 211, are formed in the circumferential surface of each second cover 220. In other words, each second cover 220 has a number of through holes 221 equal to the number of second coupling position adjustment parts 211, which are provided on one end of the second stator 210.

Meanwhile, the motor 200 has several second coupling bolts 230. Each second coupling bolt 230 is tightened into a selected one of the bolt holes 212 of the associated second coupling position adjustment part 211 after passing through the associated through hole 221, thus the position at which each second cover 220 is fastened to the second stator 210 is adjustable.

The operation and effect of the above-mentioned motor 200 having the stator made of soft magnetic powder material according to the second embodiment of the present invention will be explained herein below.

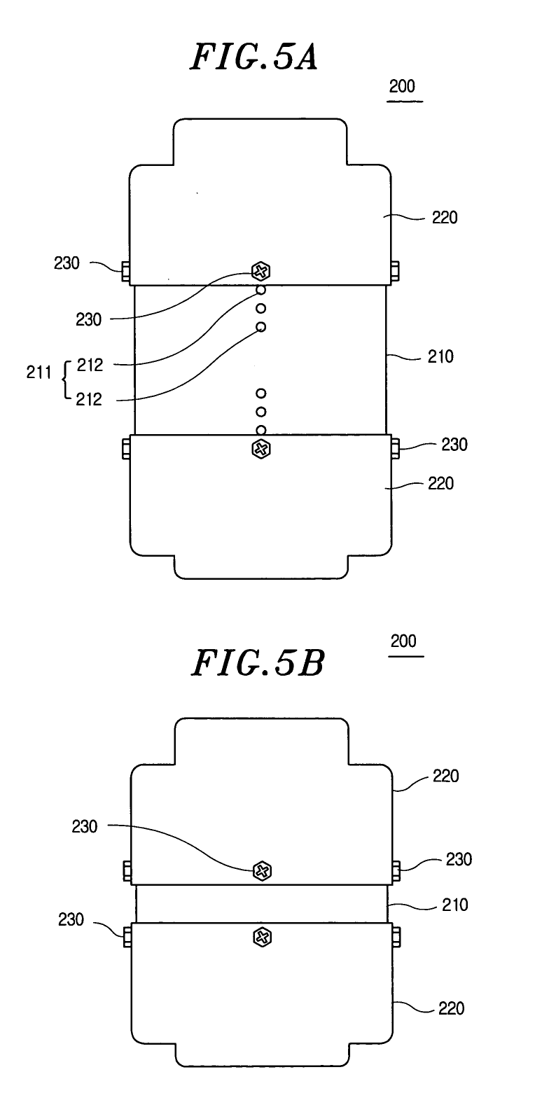

The second covers 220 are fitted over the respective opposite ends of the second stator 210. Thereafter, the second coupling bolts 230 are tightened into the selected bolt holes 212 of the respective second coupling position adjustment parts 211 via the respective through holes 221 of the second covers 220, thus fastening the second covers 220 to the second stator 210. Here, as shown in FIGS. 5A and 5B, because each second coupling bolt 230 is tightened into a selected one of the bolt holes 212 of the associated second coupling position adjustment part 211, the length of the inner space of the motor 200 or the overall length of the motor 200 can be adjusted.

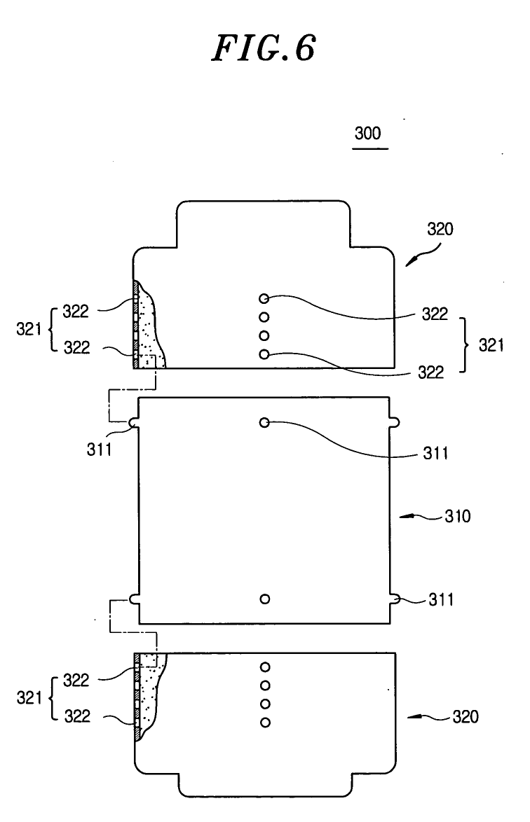

FIG. 6 is an exploded view showing critical parts of a motor 300 having a third stator 310 made of soft magnetic powder material, according to a third embodiment of the present invention. As illustrated, the motor 300 according to the third embodiment of the present invention includes the third stator 310, which is made of compressed soft magnetic powder and has a plurality of coupling protrusions 311 therein, and third covers 320, which are fitted over the respective opposite ends of the third stator 310 and have therein third coupling position adjustment parts 321 to which the respective coupling protrusions 311 are coupled. Hereinafter, the motor 300 according to the third embodiment will be explained in detail, focusing on the differences from the above-mentioned embodiments.

In the third embodiment, the third stator 310 is formed by compressing soft magnetic powder using a compressing machine, so that the coupling protrusions 311 can be relatively easily provided on the circumferential outer surface of each end of the third stator 310 at positions spaced apart from each other at regular angular intervals.

The motor 300 has the third covers 320, which are fitted over the respective opposite ends of the third stator 310. Furthermore, the coupling protrusions 311 are provided on the circumferential outer surface of each end of the third stator 310 such that each third cover 320 can be locked to the coupling protrusions 311 of each end of the third stator 310 using the third coupling position adjustment parts 321 at selected positions thereof.

As such, the two third covers 320 are fitted over the respective opposite ends of the third stator 310. The third coupling position adjustment parts 321 are provided on the circumferential surface of an end of each third cover 320 at positions spaced apart from each other at predetermined angular intervals.

Each third coupling position adjustment part 321 comprises a plurality of coupling holes 322, which are arranged in the direction in which the third stator 310 is inserted into the associated third cover 320, so that the associated coupling protrusion 311 is inserted into the selected coupling hole 322 such that the position at which the third cover 320 is fastened to the third stator 310 is adjustable.

The operation and effect of the above-mentioned motor 300 having the stator made of soft magnetic powder material according to the third embodiment of the present invention will be explained herein below.

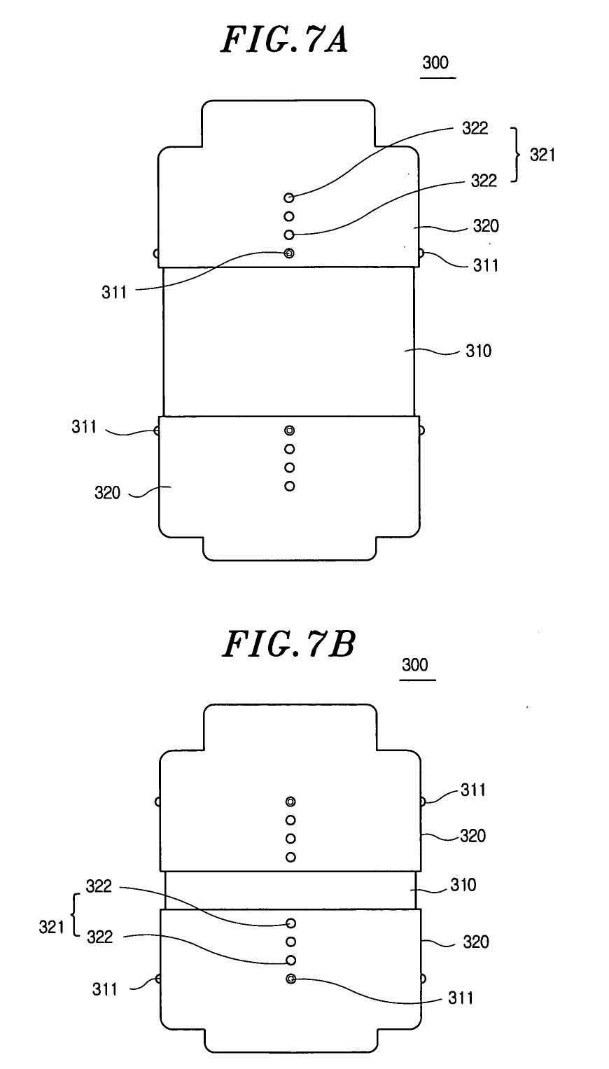

The third covers 320 are fitted over the respective opposite ends of the third stator 310 such that the coupling protrusions 311 are inserted into the coupling holes 322 of the respective third coupling position adjustment parts 321, thus the process of assembling the third covers 320 with the third stator 310 is completed. At this time, as shown in FIGS. 7A and 7B, each coupling protrusion 311 of the third stator 310 is inserted into a selected one of the coupling holes 322 of the associated third coupling position adjustment part 321. Therefore, the length of the inner space of the motor 300 or the overall length of the motor 300 is adjustable.

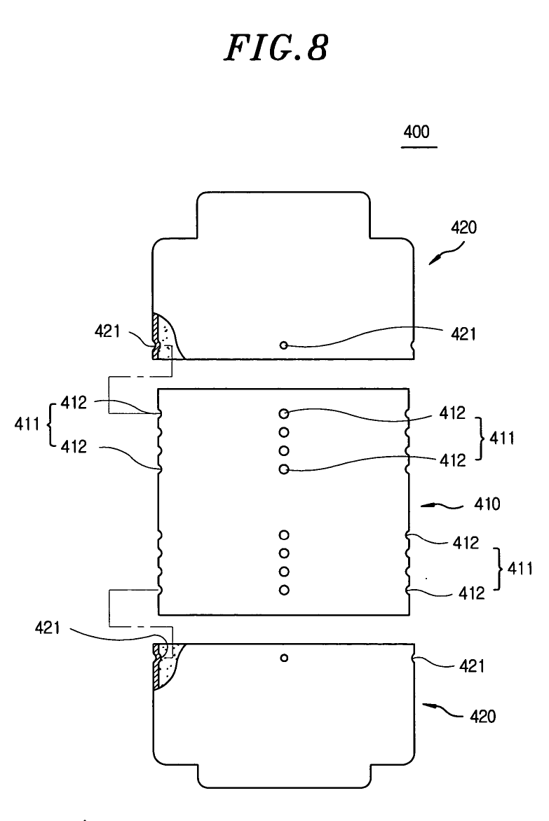

FIG. 8 is an exploded view showing critical parts of a motor 400 having a fourth stator 410 made of soft magnetic powder material, according to a fourth embodiment of the present invention. As shown in the drawings, the motor 400 according to the fourth embodiment of the present invention includes the fourth stator 410, which is made of compressed soft magnetic powder and has a plurality of fourth coupling position adjustment parts 411 therein, and fourth covers 420, which are fitted over the fourth stator 410 and have therein coupling protrusions 421 to be coupled to the respective fourth coupling position adjustment parts 411. Hereinafter, the motor 400 according to the fourth embodiment will be explained in detail, focusing on the differences with the above-mentioned embodiments.

In the fourth embodiment, the fourth stator 410 is formed by compressing soft magnetic powder using a compressing machine, so that the fourth coupling position adjustment parts 411 can be relatively easily provided in the circumferential outer surface of each end of the fourth stator 410 at positions spaced apart from each other at regular angular intervals.

Each fourth coupling position adjustment part 411 comprises a plurality of coupling holes 412, which are arranged in the longitudinal direction of the fourth stator 410.

The fourth stator 410 has the fourth coupling position adjustment parts 411 on opposite ends thereof, so that the positions at which the fourth cover 420 is fastened to each end of the fourth stator 410 using the fourth coupling protrusions 421 are independently adjustable.

The motor 400 has the two fourth covers 420, which are fitted over respective opposite ends of the fourth stator 410. The coupling protrusions 421, each of which is inserted into the selected coupling hole 412 of the associated fourth coupling position adjustment part 411, are provided on the circumferential inner surface of each fourth cover 420. In other words, each fourth cover 420 has a number of coupling protrusions 421 equal to the number of fourth coupling position adjustment parts 411, which are provided on one end of the fourth stator 410.

The operation and effect of the above-mentioned motor 400 having the stator made of soft magnetic powder material according to the fourth embodiment of the present invention will be explained herein below.

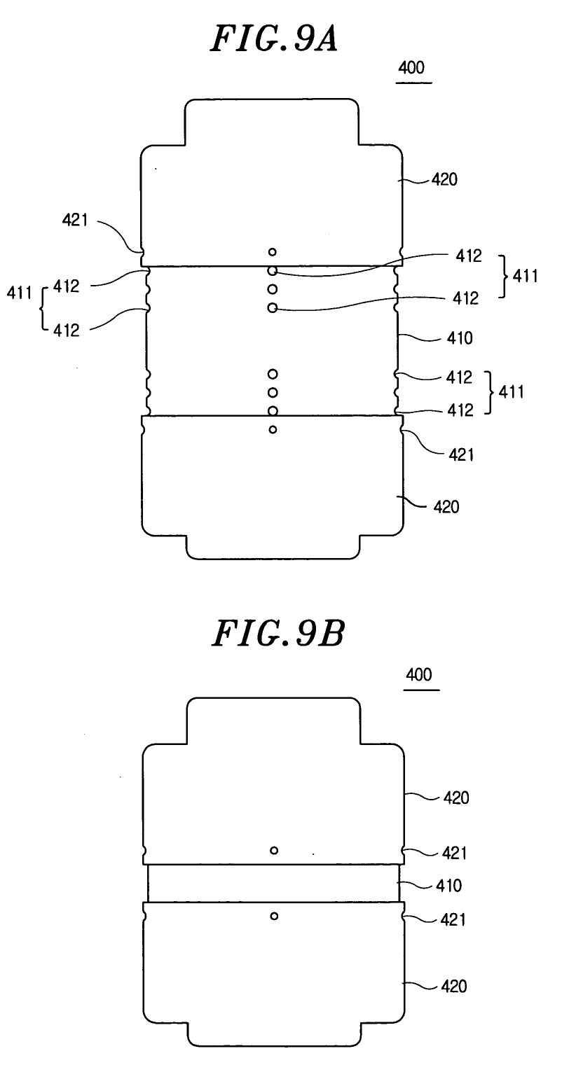

The fourth covers 420 are fitted over the respective opposite ends of the fourth stator 410 such that the coupling protrusions 421 of the fourth covers 420 are inserted into the coupling holes 412 of the respective fourth coupling position adjustment parts 411, thus the process of assembling the fourth covers 420 with the fourth stator 410 is completed. As shown in FIGS. 9A and 9B, each coupling protrusion 421 of the fourth covers 420 is inserted into a selected one of the coupling holes 412 of the associated fourth coupling position adjustment part 411. Therefore, the length of the space in the motor 400 or the overall length of the motor 400 is adjustable.

As described above, in the first through fourth embodiments of the present invention, the first through fourth covers 120, 220, 320 and 420 are respectively coupled to the first through fourth stators 110, 210, 310 and 410 using the first and second coupling bolts 130 and 230 or the coupling protrusions 311 and 421, each of which is relatively short. Thus, each of the first through fourth stators 110, 210, 310 and 410 may be opened only at one end thereof, and the assembly process is simple. Therefore, maintenance is convenient. Furthermore, because the inner space of the motor 100, 200, 300, 400 or the overall length thereof is adjustable, the present invention can easily respond to changes in the standard sizes of motors, and the measurements thereof can be easily changed.

In addition, because the first through fourth stators 110, 210, 310 and 410 are made of compressed soft magnetic powder, the bolt holes 111 and 212, the coupling protrusions 311 and the coupling holes 412 can be easily formed to couple the first through fourth covers 120, 220, 320 and 420 to the respective first through fourth stators 110, 210, 310 and 410.

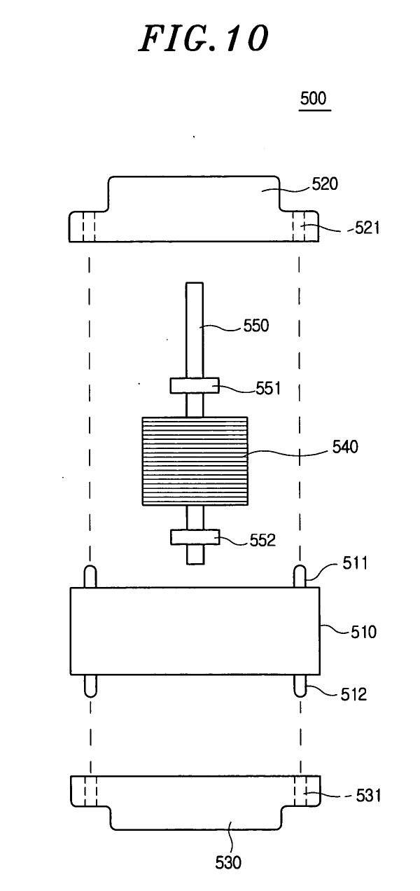

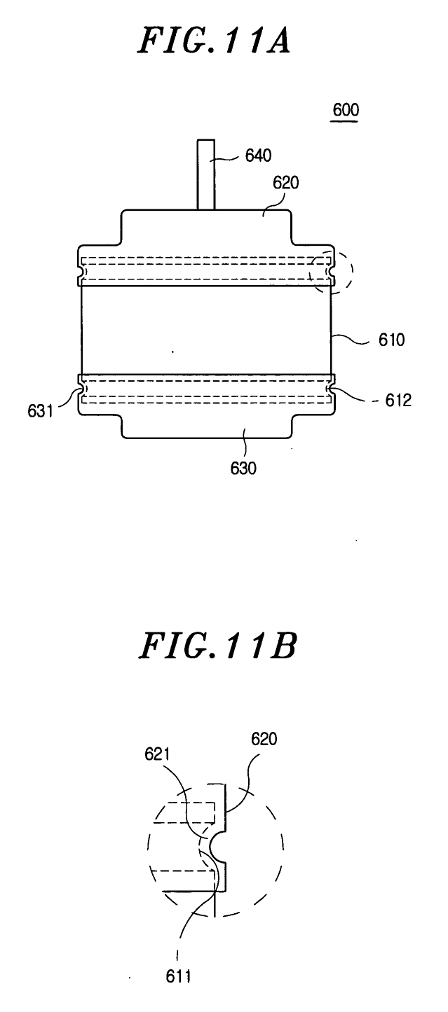

Hereinafter, the construction of motors according to fifth and sixth embodiments of the present invention will be explained with reference to FIGS. 10 and 11.

FIG. 10 is an exploded view showing critical parts of the motor 500 having a stator 510 made of soft magnetic powder material, according to the fifth embodiment of the present invention. As shown in the drawing, the motor 500 according to the fifth embodiment of the present invention includes the stator 510, which is made of compressed soft magnetic powder, and covers 520 and 530, which are coupled to the respective opposite ends of the stator 510 by a force-fitting method. The motor 500 according to the fifth embodiment further includes a rotor 540, which is rotatably provided in the stator 510 at a position spaced apart from the inner surface of the stator 510 by a predetermined gap, and a shaft 550, which is firmly fastened through the central portion of the rotor 540.

Teeth (not shown) for coils (not shown) to be wound thereon are formed on the circumferential inner surface of the stator 510 at positions spaced apart from each other at regular intervals. A plurality of insert protrusions 511 and 512 are provided on the opposite ends of the stator 510 in a direction parallel to the shaft 550.

Meanwhile, a single cover 520 or 530 may be provided on only one end of the stator 510. In this case, the stator 510 is closed at the other end thereof, and a plurality of insert protrusions 511 or 512 is formed only on the corresponding end of the stator 510. In the present embodiment, the insert protrusions 511 and 512 are provided on the respective opposite ends of the stator 510, and the two covers 520 and 530 are coupled to the respective opposite ends of the stator 510 by the force-fitting method using the insert protrusions 511 and 512.

In detail, the covers 520 and 530 comprise the top cover 520 and the bottom cover 530 which are respectively coupled to the upper and lower ends of the stator 510. The covers 520 and 530, which are coupled to respective opposite ends of the stator 510, protect the rotor 540 provided in the stator 510. The opposite ends of the shaft 550 are rotatably supported by the covers 520 and 530 through bearings 551 and 552, respectively.

In addition, insert holes 521 and 531, into which the insert protrusions 511 and 512 are respectively fitted, are formed in surfaces of the respective covers 520 and 530, which face each other based on the stator 510 placed therebetween, that is, face the stator 510.

The operation and effect of the above-mentioned motor 500 having the stator made of soft magnetic powder material according to the fifth embodiment of the present invention will be explained herein below.

The insert protrusions 511 and 512 of the stator 510 are respectively force-fitted into the insert holes 521 and 531 of the covers 520 and 530, so that the covers 520 and 530 are respectively coupled to the opposite ends, that is, to the upper and lower ends of the stator 510. Here, the rotor 540 is placed beforehand in the stator 510, and the shaft 550 is supported by the covers 520 and 530 so as to be smoothly rotatable using the bearings 551 and 552. As such, because the covers 520 and 530 are coupled to the stator 510 by the force-fitting method, the process of assembling them is simplified without requiring extra coupling members such as bolts and nuts.

Furthermore, because the stator 510 is made of compressed soft magnetic powder, the insert protrusions 511 and 512 for coupling the covers 520 and 530 to the stator 510 can be formed on the stator 510 relatively easily, unlike the conventional structure, in which silicon steel plates having the same shape are layered.

FIGS. 11A and 11B are assembled views showing critical parts of a motor 600 having a stator 610 made of soft magnetic powder material, according to a sixth embodiment of the present invention. As illustrated, the motor 600 according to the sixth embodiment of the present invention includes the stator 610, which is made of compressed soft magnetic powder, covers 620 and 630, which are coupled to the respective opposite ends of the stator 610 by caulking, a rotor (not shown), which is rotatably provided in the stator 610 at a position spaced apart from the inner surface of the stator 610 at a predetermined gap, and a shaft 640, which is firmly fastened through the central portion of the rotor.

In the sixth embodiment, the stator 610 is made of compressed soft magnetic powder in the same manner as that of the fifth embodiment. Thus, locking grooves 611 and 612 can be easily formed around the circumferential outer surfaces of the respective opposite ends of the stator 610, unlike the conventional structure, in which silicon steel plates having the same shape are layered.

Here, only one cover 620 or 630 may be coupled to one end of the stator 610 by caulking. In this embodiment, the stator 610 is closed at the other end thereof, and the covers 620 and 630 are coupled to the respective opposite ends of the stator 610 by caulking. Therefore, the locking grooves 611 and 612 are also formed in the respective opposite ends of the stator 610.

Furthermore, the covers 620 and 630 are coupled to the respective opposite ends of the stator 610 by forming caulking parts 621 and 631, which protrude into the respective locking grooves 611 and 612, in the covers 620 and 630 at positions corresponding to the respective locking grooves 611 and 612 when the covers 620 and 630 are fitted over the respective opposite ends of the stator 610.

Each caulking part 621, 631 may be formed discontinuously around the cover 620, 630. It is preferable that each caulking part 621, 631 be formed around the cover 620, 630 into a single body without interruption.

The operation and effect of the above-mentioned motor 600 having the stator made of soft magnetic powder material according to the sixth embodiment of the present invention will be explained herein below.

While the rotor (not shown) and the shaft 640 are placed in the stator 610, the covers 620 and 630 are fitted over the respective opposite ends of the stator 610. Subsequently, portions of the covers 620 and 630 corresponding to the locking grooves 611 and 612 are processed by caulking, thus forming the caulking parts 621 and 631. As such, because the caulking parts 621 and 631 are formed to be inserted into the respective locking grooves 611 and 612 of the stator 610, the covers 620 and 630 can be reliably coupled to the respective opposite ends of the stator 610 without requiring extra coupling members such as bolts and nuts.

In addition, because the stator 610 is made of compressed soft magnetic powder, locking grooves 611 and 612 can be relatively easily formed in the stator 610, unlike the conventional structure, in which silicon steel plates having the same shape are layered.

Furthermore, in this embodiment, in which the covers 620 and 630 are coupled to the stator 610 by caulking, the distance between the covers 620 and 630 can be adjusted depending on the depths to which the opposite ends of the stator 610 are inserted into the covers 620 and 630, that is, depending on the caulked positions. Thus, when it is desired to change the length of the motor 600, it is unnecessary to re-engineer covers 620 and 630 or other elements to respond to new standards, thus markedly reducing the unit cost of production.

As described above, the present invention provides a motor having a stator made of soft magnetic powder material in which a process of assembling a cover to the stator is simple, and the standard sizes, such as the length of the space in the motor, can be easily changed, so that, even though products have different standard sizes, the covers and the stators thereof are compatible, thus reducing the unit cost of production.

Furthermore, the motor according to the present invention is constructed such that the cover can be easily coupled to the stator without requiring extra coupling members. Therefore, the assembly process is simplified, thus increasing productivity, reducing the cost of the assembly process, and reducing the unit cost of production.

Although the preferred embodiments of the motor having a stator made of soft magnetic powder material have been disclosed, these are only illustrative examples. The present invention is not limited to the preferred embodiments. Those skilled in the art will appreciate that various modifications, additions and substitutions are possible, without departing from the scope and spirit of the invention as disclosed in the accompanying claims.

What is claimed is:

1. A motor, comprising:
a stator made of compressed soft magnetic powder, with a plurality of bolt holes formed around a circumferential outer surface of an end of the stator;
a cover fitted over the end of the stator, with a plurality of coupling position adjustment parts provided around an end of the cover, the coupling position adjustment parts each comprising a plurality of through holes arranged in a direction in which the cover is fitted over the stator; and
a plurality of coupling bolts, each of the plurality of coupling bolts being tightened into each of the bolt holes of the stator through the selected through hole of the associated coupling position adjustment part of the cover such that a position at which the cover is coupled to the stator is adjustable.

2. The motor as set forth in claim 1, wherein
the cover comprises a pair of covers fitted over opposite ends of the stator, and
the bolt holes are formed in each of opposite ends of the stator so that each of positions for coupling the pair of covers to the respective opposite ends of the stator is adjustable.

3. A motor, comprising:
a stator made of compressed soft magnetic powder, with a plurality of coupling position adjustment parts provided around a circumferential outer surface of an end of the stator, the coupling position adjustment parts each comprising a plurality of bolt holes arranged in a longitudinal direction of the stator;
a cover fitted over the end of the stator, with a plurality of through holes formed around a circumferential surface of the cover, each of the plurality of through holes being aligned with one of the bolt holes of the associated coupling position adjustment part of the stator; and
a plurality of second coupling bolts, each of the plurality of second coupling bolts being tightened into the selected bolt hole of each of the coupling position adjustment parts of the stator through the associated through hole of the cover such that a position at which the cover is coupled to the stator is adjustable.

4. The motor as set forth in claim 3, wherein
the cover comprises a pair of covers fitted over respective opposite ends of the stator, and
the coupling position adjustment parts are provided in each of the opposite ends of the stator so that each of positions for coupling the pair of covers to the respective opposite ends of the stator is adjustable.

5. A motor, comprising:
a stator made of compressed soft magnetic powder, with a plurality of coupling protrusions provided around a circumferential outer surface of an end of the stator; and
a cover fitted over the end of the stator, with a plurality of coupling position adjustment parts provided around an end of the cover, the coupling position adjustment parts each comprising a plurality of coupling holes arranged in a direction in which the cover is fitted over the stator, each of the plurality of coupling protrusions of the stator being inserted into the selected coupling hole of the associated coupling position adjustment part of the cover such that a position at which the cover is coupled to the stator is adjustable.

6. The motor as set forth in claim 5, wherein
the cover comprises a pair of covers fitted over respective opposite ends of the stator, and
the coupling protrusions are provided on each of the opposite ends of the stator so that each of positions for coupling the pair of covers to the respective opposite ends of the stator is adjustable.

7. A motor, comprising:
a stator made of compressed soft magnetic powder, with a plurality of coupling position adjustment parts provided around a circumferential outer surface of an end of the stator, the coupling position adjustment parts each comprising a plurality of coupling holes arranged in a longitudinal direction of the stator; and
a cover fitted over the end of the stator, with a plurality of coupling protrusions provided around a circumferential inner surface of the cover, each of the plurality of coupling protrusions inserted into the selected coupling hole of the associated coupling position adjustment part of the stator such that a position at which the cover is coupled to the stator is adjustable.

8. The motor as set forth in claim 7, wherein
the cover comprises a pair of covers fitted over respective opposite ends of the stator, and
the coupling position adjustment parts are provided in each of the opposite ends of the stator so that each of positions for coupling the pair of covers to the respective opposite ends of the stator through the coupling protrusion is adjustable.

9. A motor having a stator, to which a cover is coupled, wherein
the stator is made of compressed soft magnetic powder and has on an end thereof a plurality of insert protrusions, which are force-fitted into respective insert holes formed in the cover.

10. A motor having a stator, to which a cover is coupled, wherein
the stator is made of compressed soft magnetic powder, and a locking groove is formed around a circumferential outer surface of an end of the stator such that a caulking part to be formed by caulking in the cover fitted over the end of the stator is inserted into and locked to the locking groove of the stator.
